(19) United States
(12) Patent Application Publication
(10) Pub. No.: US 2006/0054204 A1
(43) Pub. Date: Mar. 16, 2006

(54) Warewash machine arm mount assembly

(76) Inventor: David L. Fischer, Troy, OH (US)

Correspondence Address: THOMPSON HINE LLP, 2000 COURTHOUSE PLAZA N.E., 10 WEST SECOND STREET, DAYTON, OH, 45402-1758, US

(21) Appl. No.: 10/940,568

(22) Filed: Sep. 14, 2004

(51) Int. Cl. B08B 3/02

(52) U.S. Cl. 134/176; 134/179; 134/201; 134/198

(57) ABSTRACT

A wash arm assembly includes a wash arm and a mount assembly connected to the wash arm. The mount assembly is configured to occlude a potential leak path extending through the mount assembly at a first location along the potential leak path with the wash arm assembly in a first orientation and to occlude the potential leak path at a second location along the leak path different from the first location with the wash arm assembly in a second orientation different from the first orientation.

### TECHNICAL FIELD

The present application relates to a mount assembly, and more particularly to a mount assembly for mounting a liquid dispensing arm within a warewash machine.

### BACKGROUND

Warewash machines utilize rotating rinse arms to deliver heated, fresh rinse water onto wares during a rinsing operation of a machine cycle. In some cases, a warewash machine includes both an upper, hanging rinse arm assembly and a lower, standing rinse arm assembly. The upper and lower rinse arm assemblies include respective bearing assemblies that mount the respective rinse arm within the warewash machine and also allow the upper and lower rinse arms to rotate during use. It would be desirable to provide a bearing system that also acts as a sealing assembly.

### SUMMARY

A mount assembly for use in mounting a liquid dispensing arm can be positioned in either a standing orientation for mounting a lower arm or a hanging orientation for mounting an upper arm. In either orientation water leakage through the mount assembly is limited by a sealing assembly.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a perspective view of an embodiment of a warewash machine;

FIG. 2 is a section view of a washing chamber of the warewash machine of FIG. 1 including upper and lower rinse arms;

FIG. 3 is a section view of an embodiment of a rinse arm mount assembly;

FIGS. 4 and 4A are section and end views, respectively, of an embodiment of a first outer connecting member of the mount assembly of FIG. 3;

FIGS. 5 and 5A are section and end views, respectively, of an embodiment of a second outer connecting member of the mount assembly of FIG. 3;

FIGS. 6 and 6A are section and end views, respectively, of an embodiment of an inner member of the mount assembly of FIG. 3;

FIGS. 7 and 7A are section and end views, respectively, of an embodiment of a flange bushing, which also acts as a thrust washer;

FIGS. 8 and 8A are section and end views, respectively, of an embodiment of a sealing ring of the mount assembly of FIG. 3;

FIG. 9 is an exploded view of the mount assembly of FIG. 3;

FIG. 10 is section view of the mount assembly of FIG. 3; and

FIGS. 11 and 12 are section views of the mount assembly of FIG. 3 in standing and hanging positions, respectively.

### DETAILED DESCRIPTION

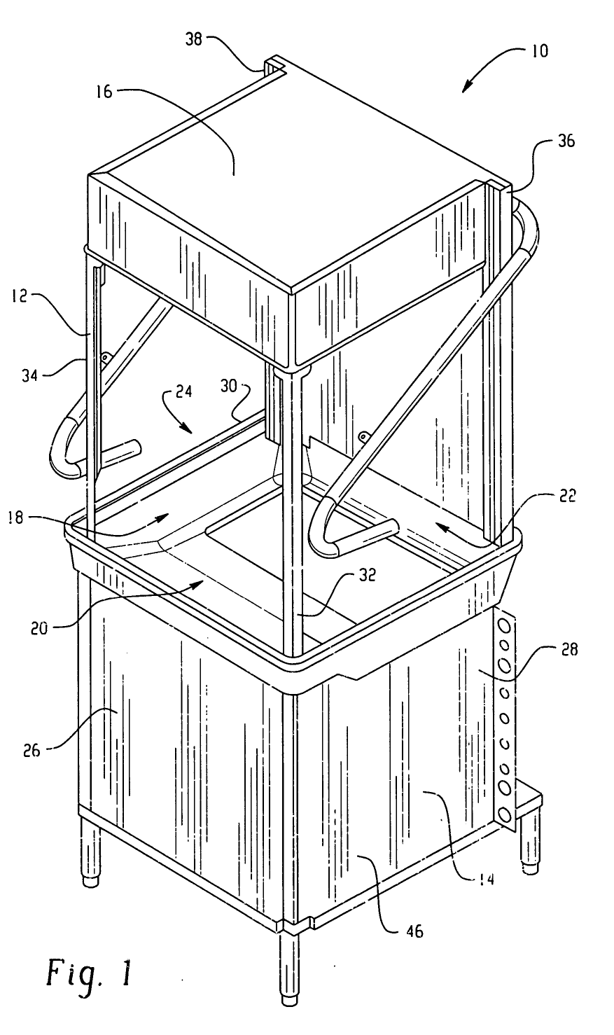

Referring to FIG. 1, a warewash machine 10 includes a frame 12, a lower housing 14, an upper housing 16 spaced from the lower housing and a washing chamber 18 located between the upper and lower housings. For the placement and removal of wares into and out of the washing chamber 18, a set of access openings 20, 22, 24 are provided. The access openings 20, 22, 24 are disposed at the front 26 and sides 28, 30, respectively, of the warewash machine 10 and are each formed between the upper and lower housings 14, 16 and associated frame members 32, 34, 36, 38.

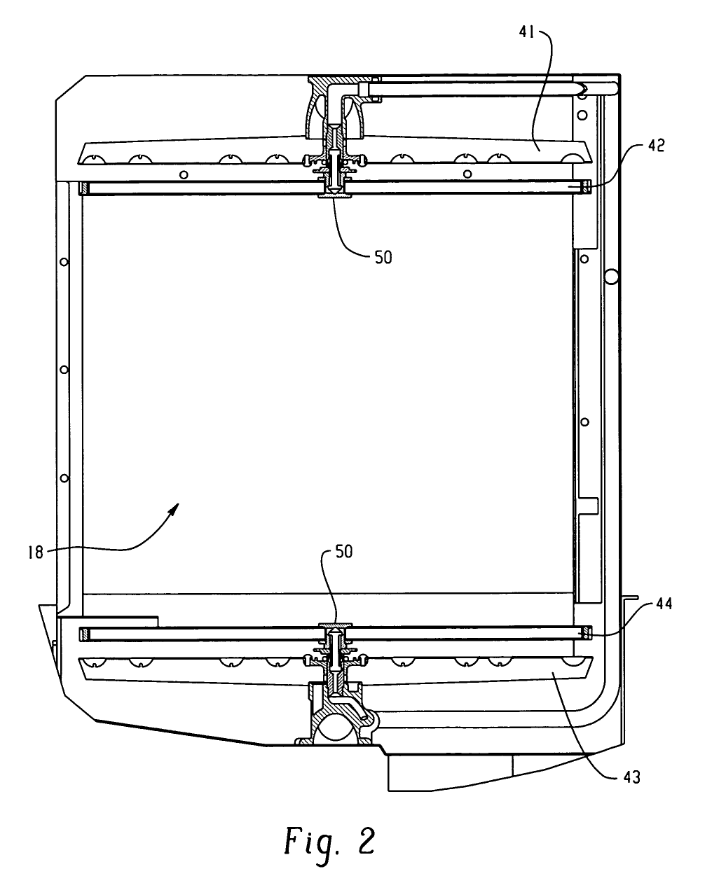

Referring to FIG. 2, located within the washing chamber 18 are upper and lower sets of liquid dispensing arms 41, 42 and 43, 44. Arms 41 and 43 represent wash arms used to dispense wash liquid onto wares during a washing step of a cycle. The wash liquid may be recirculated by a suitable pump through a wash liquid tank 46 located beneath the washing chamber 18 to receive the wash liquid as it falls from the wares (see FIG. 1). The arms 42 and 44 represent rinse arms used to dispense rinse liquid, such as heated fresh water, onto wares during a rinsing step of a cycle. The tank 46 may typically include an overflow drain as well as a manual or automatic drain mechanism to enable draining of the entire tank. While both upper and lower sets of arms are shown, other configurations are possible. During operation, the arms typically rotate under forces generated by the liquid dispensed from the arm nozzles onto the wares.

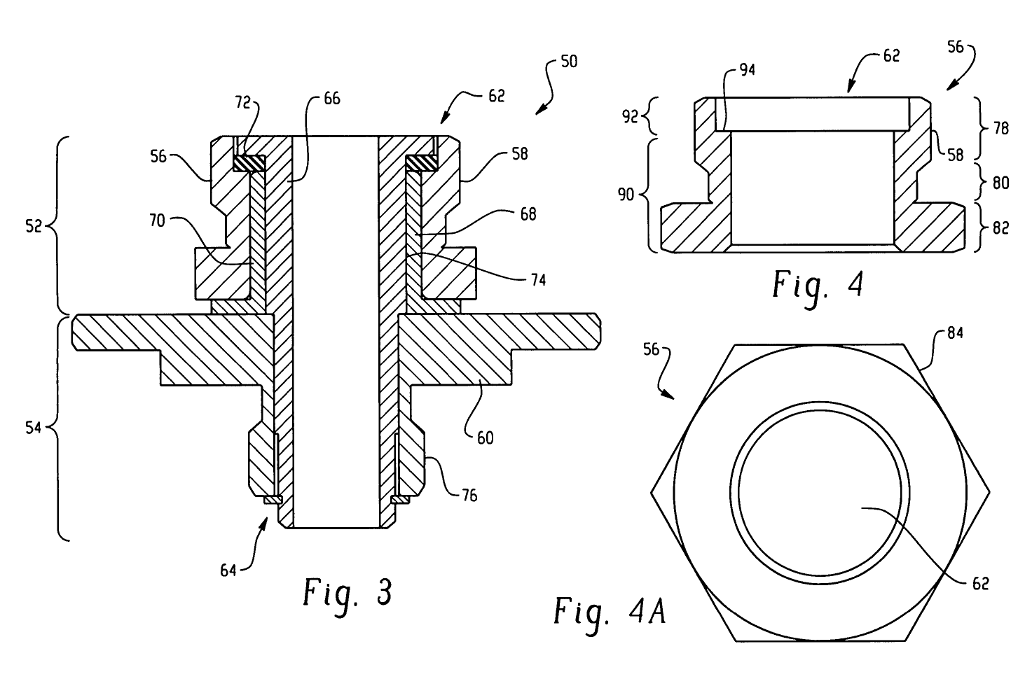

The upper and lower rinse arms 42, 44 are mounted within the warewash machine 10 for rotational movement using a mount assembly 50. Referring now to FIG. 3, the mount assembly 50 includes a distal rotating portion 52 that can be connected (e.g., via a threaded connection, press fit connection, etc.) to a rinse arm and a proximal fixed portion 54 that can be connected to a fluid outlet (e.g., via a threaded connection, press fit connection, etc.) to a casting within the washing chamber, or to a mount assembly in either of the wash arms 41 and 43.

The mount assembly 50 is a coaxial design that includes a first outer connecting member 56 having a threaded outer surface 58 for connecting the mount assembly 50 to the rinse arm and a second outer connecting member 60 also having a threaded outer surface 76 for connecting the mount assembly to the fluid outlet. Each of the first and second outer connecting members 56 and 60 includes an opening 62 and 64, respectively. The openings 62 and 64 are aligned axially to receive an inner member 66 that is inserted through each of the openings 62 and 64. Disposed between the inner member 66 and the first outer connecting member 56 is a sealing assembly 68 that includes a flanged bushing 70 and an annular sealing ring 72. As will be described in greater detail below, the sealing assembly 68 can be used to seal a leak path 74 disposed between the inner member 66 and first outer connecting member 56 while also allowing for rotation of the first outer connecting member relative to the inner member during use.

Referring to FIG. 4, the first outer member 56 includes a threaded portion 78 including the threaded outer surface 58, an undercut portion 80 of reduced outer diameter and a flange portion 82 of increased outer diameter. As can be seen by FIG. 4A, the flange portion 82 includes multiple side surfaces 84, e.g., to facilitate grasping and rotating of the first outer member, for example, when connecting or disconnecting the first outer member to the rinse arm. As shown, the flange portion 82 is a hexagonal design, but any other suitable design can be used. Referring back to FIG. 4, extending between opposite ends 86 and 88 of the first outer member 56 is opening 62. Opening 62 has a smaller diameter portion 90 and a larger diameter portion 92 forming a necked-down seating surface 94 that forms a transition between the portions 90 and 92.

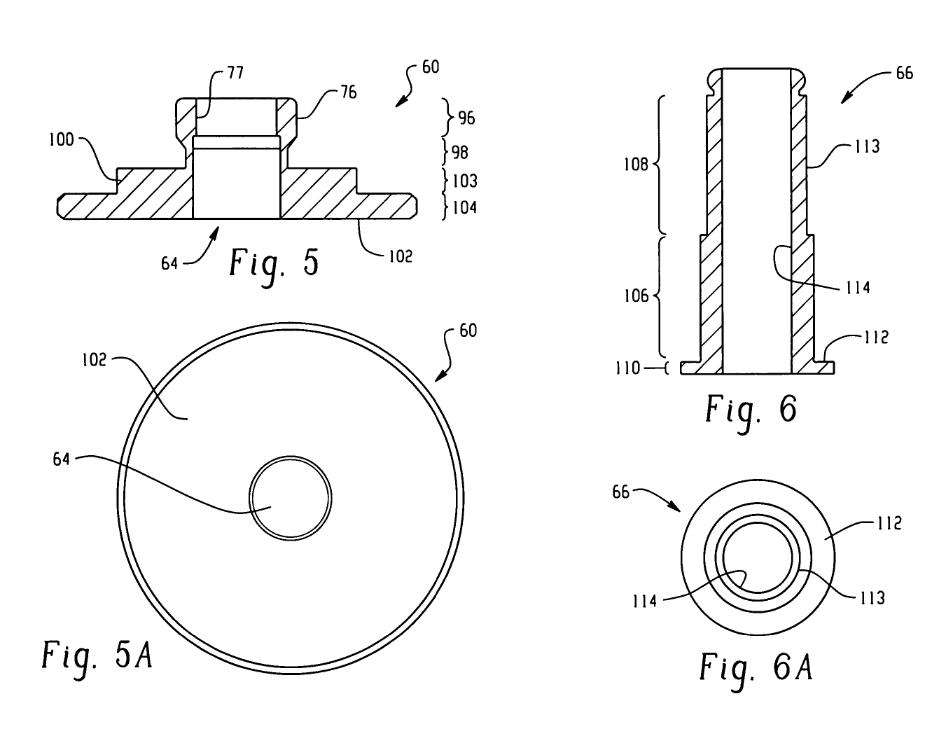

Referring now to FIGS. 5 and 5A, the second outer connecting member 60 provides an attachment for connecting the mount assembly 50 to a fluid outlet. The second outer connecting member 60 includes a threaded portion 96 having the threaded outer surface 76 and a threaded inner surface 77, an undercut portion 98 of reduced outer diameter, an outwardly extending, stepped flange 100 having regions 103, 104 of differing outer diameters, an upper seating surface 102 and opening 64.

Providing an inner race for the mount assembly 50, referring to FIGS. 6 and 6A, is the inner member 66 about which the first outer connecting member 56 can rotate and to which the second outer member 60 can be fixedly connected to. The inner member 66 includes a first portion 106, a stepped down second portion 108 of lesser outer diameter than the first portion 106 and a flange portion 110 having a lower seating surface 112. The second portion has a threaded outer surface 113 for securing the inner member 66 and second outer connecting member 60 together. Extending through the inner member 66 is a fluid passageway 114 for providing fluid to the rinse arm during operation.

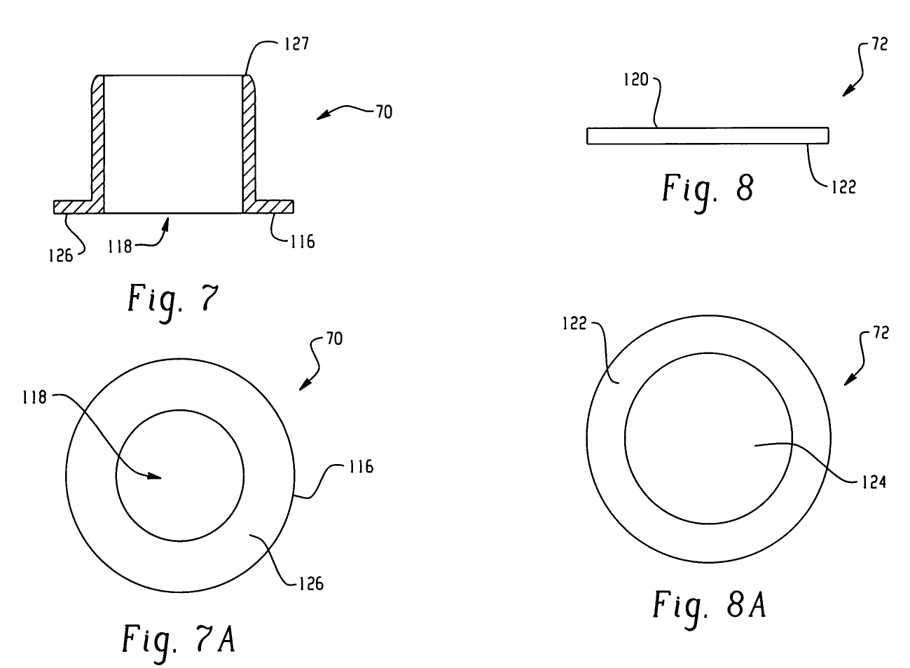

As noted above, when assembled, the sealing assembly 68 helps to seal a leak path formed between the inner member 66 and the first outer connecting member 56. Details of the leak path and sealing of the leak path will be described in greater detail below. Referring to FIGS. 7 and 7A, the bushing 70 of the sealing assembly 68 includes a flange 116 at one end to form a seating surface 126. The opposite end of the bushing includes a seating surface 127. An opening 118 is sized to receive the inner member 66. Referring to FIGS. 8 and 8A the sealing ring 72 of the sealing assembly 68 includes opposed sealing surfaces 120 and 122 and an opening 124 that is sized to receive the inner member 66.

Suitable materials for forming the first and second outer connecting members 56, 60 and inner member 66 includes food grade, underwater materials, such as stainless steel. Suitable materials for forming the sealing assembly 68 include plastics or composite plastics, such as the H370 composite plastic of IGUS, Inc.

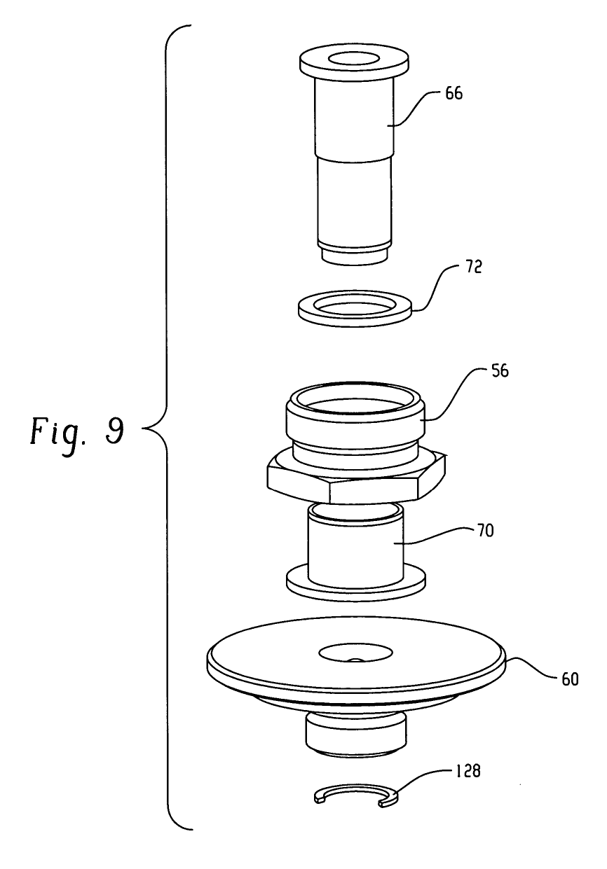

Referring now to FIG. 9, in assembling the mount assembly 50, the inner member 66 is inserted through respective openings through the sealing ring 72, first outer connecting member 56, flanged bushing 70 and second outer connecting member 60. The flanged bushing is press fitted into the outer member 56. The inner member 66 is passed through the member 56 and flanged bushing 70, with the flange portion 110 trapping the sealing ring 72, and the member 60 is threaded onto the lower end if member 66 to hold the entire assembly together. The first outer connecting member 56 and bushing 70 can rotate relative to the inner member 66 in a bearing relationship with the inner member serving as an inner race about which the bushing 70 and first outer connecting member 56 rotate. The second outer member's position relative to the inner member 66 is fixed due to the threaded connection.

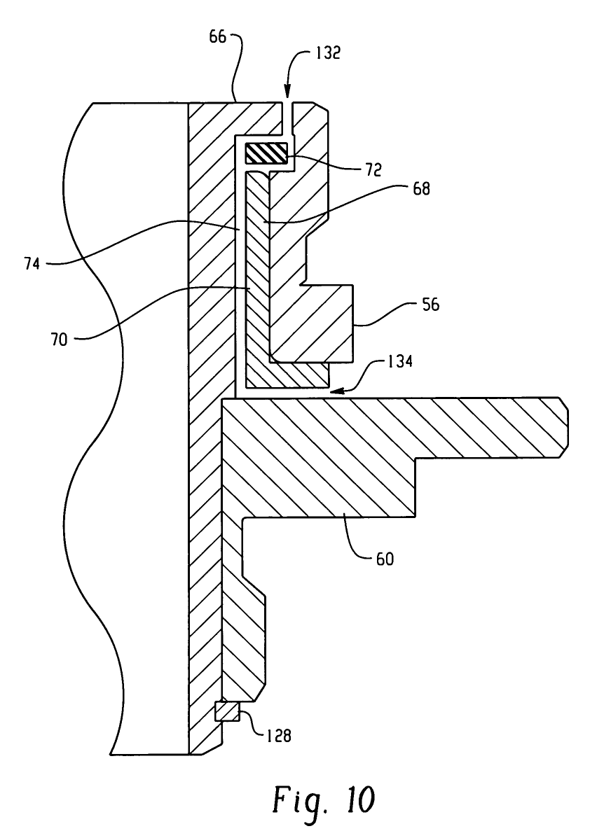

Referring to FIG. 10, as assembled, the potential leak path 74 is formed between the first outer connecting member 56 and the inner member 66 and extends from a leak inlet 132 to a leak outlet 134. The presence of leak path 74 provides a passage through which fluid could leak from the rinse arm through the mount assembly 50 due to operational pressures, which can decrease system efficiency and increase cost. Sealing assembly 68 is provided to occlude the leak path 74 and block off the leak outlet 134 at differing locations in respective standing and hanging orientations to increase system efficiency in either orientation.

Referring now to FIG. 11, the mount assembly 50 is in the standing position with end 136 of the mount assembly facing upward (e.g., to mount a lower wash arm 43 and lower rinse arm 44 as per FIG. 2). In this position, the sealing assembly 68 and first outer connecting member 56 are biased toward the seating surface 102 of the second outer connecting member 60 due primarily to the weight of the wash arm (not shown, see FIG. 2) attached to the first outer connecting member. During rotation of the rinse arm and member 56, bushing 70 also rotates and flange 116 acts as a bearing or thrust washer against member 60. In the standing position, the seating surfaces 126 and 102 of the sealing member 68 and second outer connecting member 60 are pressed together to form a seal that, in some cases, prevents leakage through the outlet 134 of the leak path 74, while in other cases the seal occludes the potential leak path to only allow relatively low amounts (in some cases, less than about 0.050 gallons per minute at a pressure of 20 psi, or even less than 0.020 gallons per minute at 20 psi) of leakage through the outlet 134.

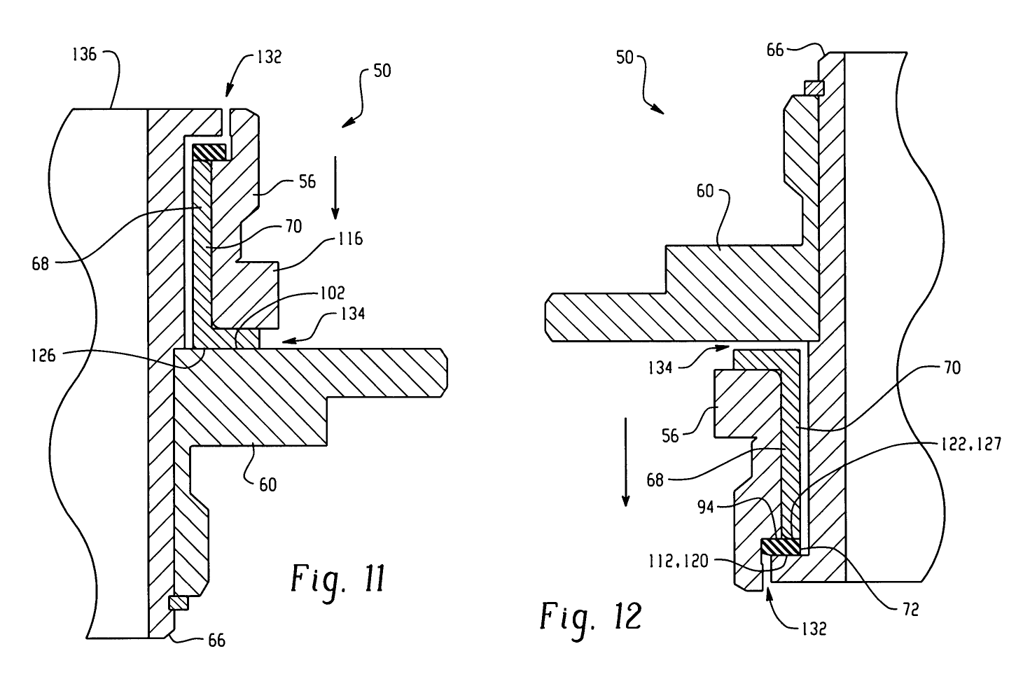

FIG. 12 shows the mount assembly 50 in the hanging position with end 136 of the mount assembly facing downward (e.g., to mount an upper wash arm 41 and an upper rinse arm 42 as per FIG. 2). In this position, the bushing 70 and sealing ring 72 of the sealing assembly 68 and first outer connecting member 56 are biased toward the seating surface 112 of the inner member 66 due primarily to the weight of the wash arm (not shown). During rotation of the rinse arm and member 56, bushing 70 also rotates and sealing ring 72 acts as a bearing or thrust washer between surface 94 of member 56 and surface member 66. A sealing effect is achieved on both sides of the sealing ring 72. In the hanging position, the seating surfaces 112, 120, 122, 127, 94 of the inner member 66, sealing assembly 68 and first outer connecting member 56 are pressed together to form a seal that, in some cases, prevents all leakage through the outlet 134 of the leak path 74, while in other cases, the seal occludes the potential leak path to only allow relatively low amounts (in some cases, less than about 0.050 gallons per minute at a pressure of 20 psi, or even less than 0.020 gallons per minute at 20 psi) of leakage through the outlet 134.

As used herein the term “seal” refers to a restriction that reduces liquid flow along a liquid path and includes, but should not be limited to, a no leakage seal.

A number of embodiments of the invention have been described. Nevertheless, it will be understood that various modifications may be made without departing from the spirit and scope of the invention. For example, while the mount assembly has been described primarily for use with a rinse arm, it could be used in connection with a wash arm. Accordingly, other embodiments are within the scope of the following claims.

What is claimed is:

1. A mount assembly for use in mounting a liquid dispensing arm for rotating movement within a warewash machine, the mount assembly comprising:
an outer member;
an inner member disposed within an opening of the outer member such that the outer member is capable of rotating relative to the inner member;
a potential leak path at least partially disposed between the inner and outer members, the leak path having first and second ends; and
a seal assembly configured to seal the first end of the potential leak path with the mount assembly in a standing position and to seal the second end of the potential leak path with the mount assembly in a hanging position.

2. The mount assembly of claim 1, wherein the first end is an outlet and the second end is an inlet.

3. The mount assembly of claim 1, wherein the seal assembly is configured to open the first end of the potential leak path with the mount assembly in the hanging position.

4. The mount assembly of claim 3, wherein the seal assembly is configured to open the second end of the potential leak path with the mount assembly in the standing position.

5. The mount assembly of claim 1 further comprising a second outer member threadably connected to the inner member.

6. The mount assembly of claim 5, wherein, in the standing position, the seal assembly is pushed by gravity toward the second outer connecting member.

7. The mount assembly of claim 5, wherein, in the hanging position, the seal assembly is pushed by gravity in a direction away from the second outer member and toward a seating surface of the inner member.

8. The mount assembly of claim 1, wherein the seal assembly comprises a bushing and a sealing ring.

9. The mount assembly of claim 1, wherein at least part of the seal assembly is connected to the outer member such that the seal assembly rotates with the outer member relative to the inner member.

10. The mount assembly of claim 1, wherein the inner member has a fluid passageway extending therethrough for providing fluid communication with a rinse arm that is mounted to the outer member.

11. The mount assembly of claim 1 wherein the seal assembly includes a bushing with a flange that acts as a thrust washer and has a surface that engages another surface to from the seal in the standing position, and a sealing ring that acts as a thrust washer and includes opposed surfaces that engage respective surfaces to form the seal in the hanging position.

12. A mount assembly for use in mounting a liquid dispensing arm for rotating movement within a warewash machine, the mount assembly comprising:
an outer member;
an inner member disposed within an opening of the outer member such that the outer member is capable of rotating relative to the inner member;
a potential leak path at least partially disposed between the inner and outer members; and
a seal assembly including first and second seal members, the seal assembly configured such that:
in a first orientation, an annular surface of a thrust bearing portion of the first seal member is pressed together with a first surface to occlude the potential leak path at a first location;
in a second orientation, which is opposite the first orientation, an annular surface of a thrust bearing portion of the second seal member is pressed together with a second surface to occlude the potential leak path at a second location different from the first location.

13. The mount assembly of claim 12, wherein the second location is near an inlet of the potential leak path and the first location is near an outlet end of the potential leak path.

14. The mount assembly of claim 12, wherein, in the second orientation, the aforementioned pressing of the annular surface of the thrust bearing portion of the first seal member against the first surface is lacking.

15. The mount assembly of claim 14, wherein, in the first orientation, the aforementioned pressing of the annular surface of the thrust bearing portion of the second seal member against the second surface is lacking.

16. The mount assembly of claim 12, wherein the first orientation is a hanging orientation suitable for mounting an upper liquid dispensing arm and the second orientation is a standing orientation suitable for mounting a lower liquid dispensing arm.

17. The mount assembly of claim 12 further comprising a second outer member threadably connected to the inner member.

18. The mount assembly of claim 12, wherein the first seal member comprises a flanged bushing and the second seal member comprises an annular ring.

19. The mount assembly of claim 18, wherein the flange bushing rotates with the outer member relative to the inner member.

20. The mount assembly of claim 12, wherein the inner member has a fluid passageway extending therethrough for providing fluid communication with a rinse arm that is mounted to the outer member.

21. A rinse arm assembly comprising:
a rinse arm with a plurality of liquid outlets; and
a mount assembly connected to the rinse arm, the mount assembly configured to occlude a potential leak path extending through the mount assembly at a first location along the potential leak path with the rinse arm assembly in a first orientation and to occlude the potential leak path at a second location along the leak path different from the first location with the rinse arm assembly in a second orientation different from the first orientation, the leak path capable of fluid communication with the rinse arm.

22. The rinse arm assembly of claim 21, wherein the second location is relatively near an inlet of the potential leak path and the first location is relatively far from the inlet of the leak path.

23. The rinse arm assembly of claim 21, wherein the mount assembly is configured to open the potential leak path at the first location with the rinse arm assembly in the second orientation and to open the potential leak path at the second location with the rinse arm assembly in the first orientation.

24. The rinse arm assembly of claim 21, wherein the mount assembly includes a rotatable portion connected to the rinse arm to allow the rinse arm to rotate when mounted to a warewash machine.

25. The rinse arm assembly of claim 21, wherein the mount assembly has a fluid passageway capable of fluid communication with the rinse arm.

26. A mount assembly for use in mounting either a lower liquid dispensing arm or an upper liquid dispensing arm for rotating movement within a warewash machine, the mount assembly comprising:
a first outer connecting member configured to connect the mount assembly with a liquid dispensing arm;
a second outer connecting member adjacent the first outer connecting member and having a seating surface for forming a first seal;
an inner member received through respective openings of the first and second outer connecting members, the inner member having a fluid passageway extending therethrough and a seating surface for forming a second seal;
a sealing assembly at least partially disposed between the first outer connecting member and the inner member and having first and second seating surfaces for use in forming the respective first and second seals;
wherein when the mount assembly is used to mount a lower liquid dispensing arm with the mount assembly in a standing position, the first seating surface of the sealing assembly is pressed against the seating surface of the second outer member to form the first seal and when the mount assembly is used to mount an upper liquid dispensing arm with the mount assembly in a hanging position, the second seating surface of the sealing assembly is pressed against the seating surface of the first outer connecting member to at least partially form the second seal.
